(19) United States
(12) Patent Application Publication
(10) Pub. No.: US 2009/0248414 A1
(43) Pub. Date: Oct. 1, 2009

(54) Personal name assignment apparatus and method

(75) Inventors: Taishi Shimomori, Akishima-shi (JP); Tatsuya Uehara, Akishima-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/382,752

(22) Filed: Mar. 23, 2009

(30) Foreign Application Priority Data
Mar. 27, 2008 (JP) 2008-083430

(51) Int. Cl. G10L 17/00

(52) U.S. Cl. 704/246; 704/E17.003

(57) ABSTRACT

An apparatus includes unit acquiring speaker information including a first duration of a speaker and a name specified by name specifying information used to indicate a name, and acquiring the first duration as a first period, unit acquiring a second period including an utterance, unit extracting, if the second period is included in the first period, a first amount that characterizes a speaker, and associating the first amount with a name corresponding to the first period, unit creating speaker models from amounts, unit acquiring, from the content information, a third duration as an duration to be recognized, unit extracting, if the second period is included in the third period, a second amount that characterizes a speaker, unit calculating degrees of similarity between amounts of speaker models and the second amount, and unit recognizing a name of a speaker model which satisfies a set condition of the degrees as a performer.

### CROSS-REFERENCE TO RELATED APPLICATIONS

This application is based upon and claims the benefit of priority from prior Japanese Patent Application No. 2008-083430, filed Mar. 27, 2008, the entire contents of which are incorporated herein by reference.

### BACKGROUND OF THE INVENTION

1. Field of the Invention

The present invention relates to a personal name assignment apparatus and method, which can assign, based only on a received video picture, a personal name to a scene where a given performer appears.

2. Description of the Related Art

In a music program, a plurality of performers often do interviews and give performances in turn. In such case, the user may want to play back the video picture of a scene of a performer he or she wants to watch in the music program video-recorded in an HDD recorder or the like. If the performer name of a performer is assigned to each scene, the user can easily select the scene of a performer he or she wants to watch. As a related art that allows such viewing, a face image is detected from a received and recorded program, and is collated with those stored in advance in a face image database so as to identify a person corresponding to the detected face image. The identified information is managed as a performer database together with a point which reflects the appearance duration of that person in the program. When the user wants to watch the program, the ratios of appearance of a given performer are calculated with reference to the performer database and points, and corresponding scenes are presented in descending order of ratio (for example, see JP-A 2006-33659 (KOKAI)).

However, in order to play back a scene of a desired performer using the aforementioned related art, personal names have to be separately registered in the face image database, and when new faces or unknown persons appear, the database needs to be updated. In this manner, in the conventional method, personal names have to be separately registered in a face image or speech database, and the database needs to be updated when new faces appear.

### BRIEF SUMMARY OF THE INVENTION

In accordance with an aspect of the invention, there is provided a personal name assignment apparatus comprising: a first acquisition unit configured to acquire speaker information including a first utterance duration of a speaker and a speaker name specified by speaker name specifying information used to indicate a speaker name, from utterance content information which includes utterance content and a second utterance duration in a video picture and is attached to the video picture, and to acquire the first utterance duration as a first utterance period; a second acquisition unit configured to acquire, from a non-silent period in the video picture, a second utterance period including an utterance; a first extraction unit configured to extract, if the second utterance period is included in the first utterance period, a first feature amount that characterizes a speaker from a speech waveform of the second utterance period, and to associate the first feature amount with a speaker name corresponding to the first utterance period; a creation unit configured to create a plurality of speaker models of speakers from feature amounts for respective speakers; a storage unit configured to store speaker names and the speaker models in relationship to each other; a third acquisition unit configured to acquire, from the utterance content information, a third utterance duration as an utterance duration to be recognized; a second extraction unit configured to extract, if the second utterance period is included in the third utterance period, a second feature amount that characterizes a speaker from the speech waveform; a calculation unit configured to calculate a plurality of degrees of similarity between feature amounts of speaker models for respective speakers and the second feature amount; and a recognition unit configured to recognize a speaker name of a speaker model which satisfies a set condition of the degrees of similarity as a performer.

### BRIEF DESCRIPTION OF THE SEVERAL VIEWS OF THE DRAWING

FIG. 1 is a block diagram of a personal name assignment apparatus according to an embodiment;

FIG. 2 is a flowchart showing an example of the operation of the personal name assignment apparatus shown in FIG. 1;

FIG. 3 is a flowchart showing step S201 in FIG. 2;

FIG. 4 is a flowchart showing step S202 in FIG. 2;

FIG. 5 is a flowchart showing step S203 in FIG. 2;

FIG. 6 is a flowchart showing step S501 in FIG. 5;

FIG. 7 is a flowchart showing step S502 in FIG. 5;

FIG. 8 is a flowchart showing step S204 in FIG. 2;

FIG. 9 is a flowchart showing step S205 in FIG. 2;

FIG. 10 is a flowchart showing step S905 in FIG. 9;

FIG. 11 is a flowchart showing step S906 in FIG. 9;

FIG. 12 is a view showing an example of closed captions as utterance content information;

FIG. 13 is a view showing an example of speaker information; and

FIG. 14 is a view showing recognition target duration information acquired from utterance content information in FIG. 12 by a recognition target duration acquisition unit shown in FIG. 1.

### DETAILED DESCRIPTION OF THE INVENTION

A personal name assignment apparatus and method according to an embodiment of the present invention will be described in detail hereinafter with reference to the accompanying drawings. In the following embodiment, under the assumption that parts denoted by the same reference numerals perform the same operations, a repetitive description thereof will be avoided.

According to the personal name assignment apparatus and method of this embodiment, a personal name can be assigned to a scene where a desired performer appears based solely on a received video picture.

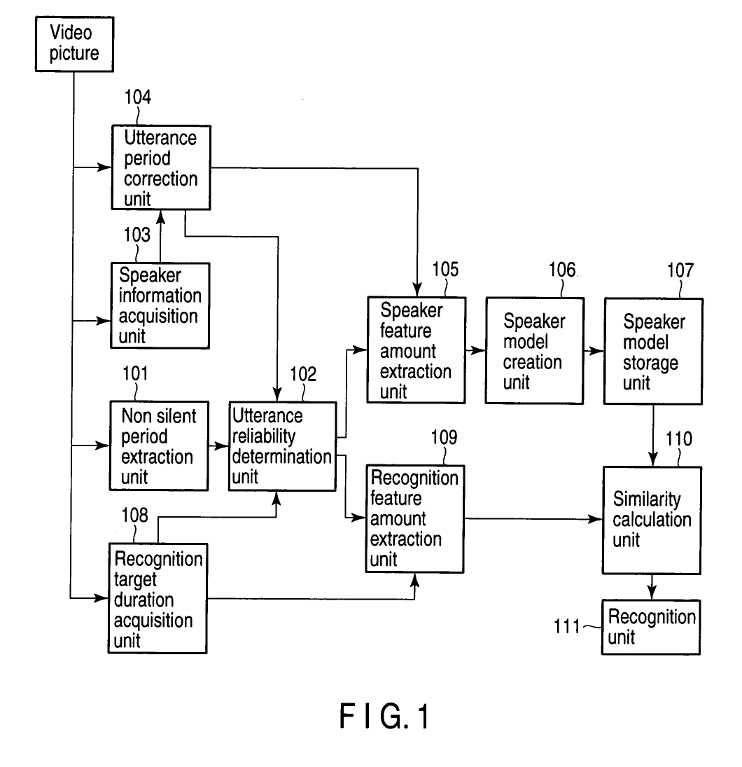

The personal name assignment apparatus of this embodiment will be described below with reference to FIG. 1.

The personal name assignment apparatus of this embodiment includes a non-silent period extraction unit 101, utterance reliability determination unit 102, speaker information acquisition unit 103, utterance period correction unit 104, speaker feature amount extraction unit 105, speaker model creation unit 106, speaker model storage unit 107, recognition target duration acquisition unit 108, recognition feature amount extraction unit 109, similarity calculation unit 110, and recognition unit 111.

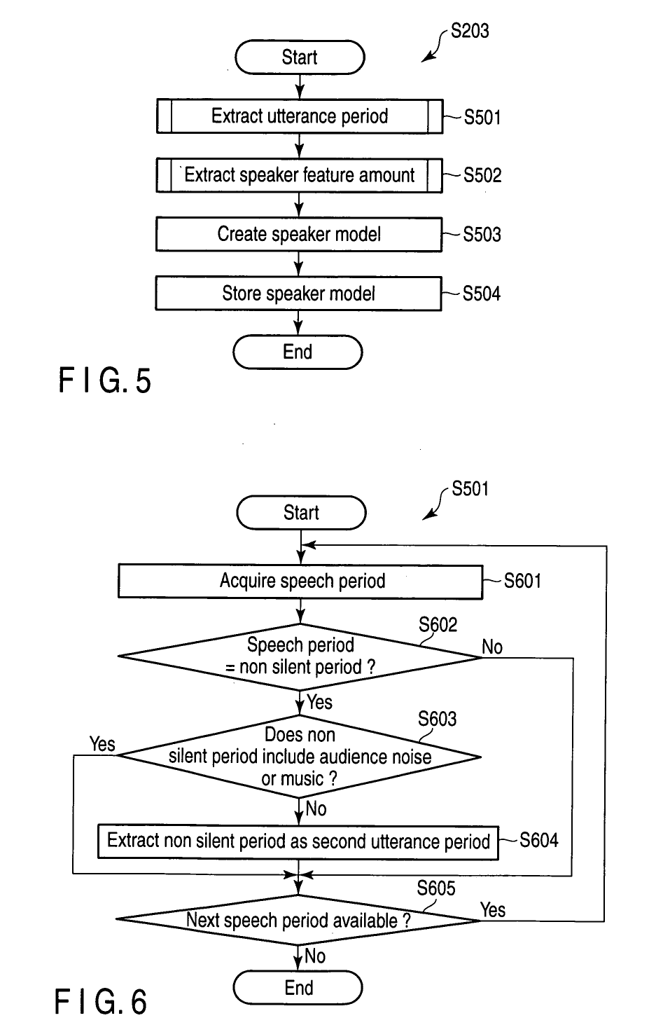

The non-silent period extraction unit 101 extracts non-silent periods of those each having a period width set at shift intervals set from speech of a video picture. The operation of the non-silent period extraction unit 101 will be described later with reference to FIG. 5.

The utterance reliability determination unit 102 determines whether or not each non-silent period is a period that does not include any audience noise or music, and extracts a period that does not include any audience noise and music as a second utterance period. The operation of the utterance reliability determination unit 102 will be described later with reference to FIG. 6.

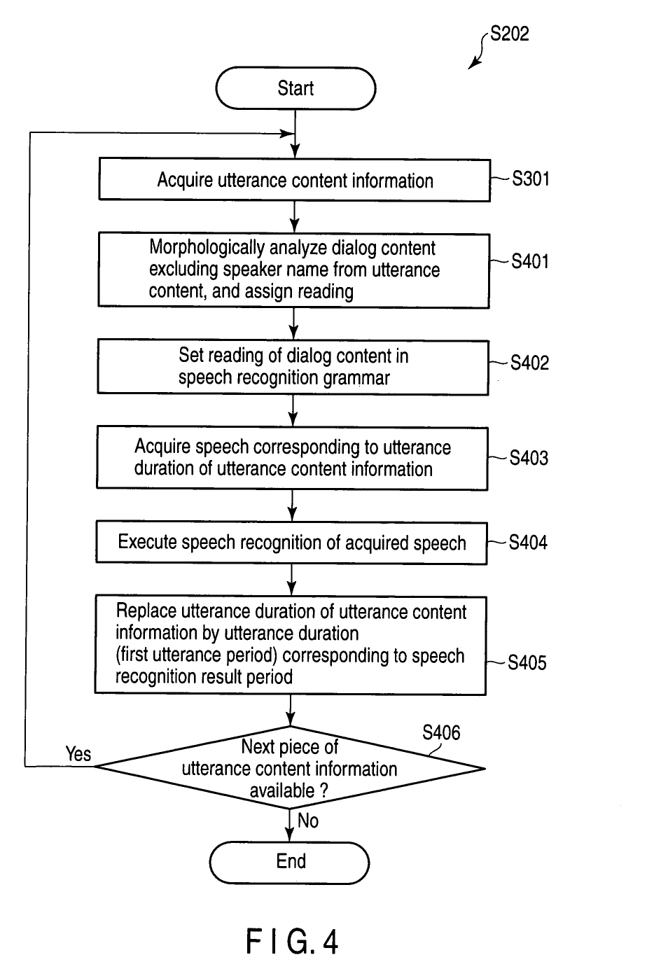

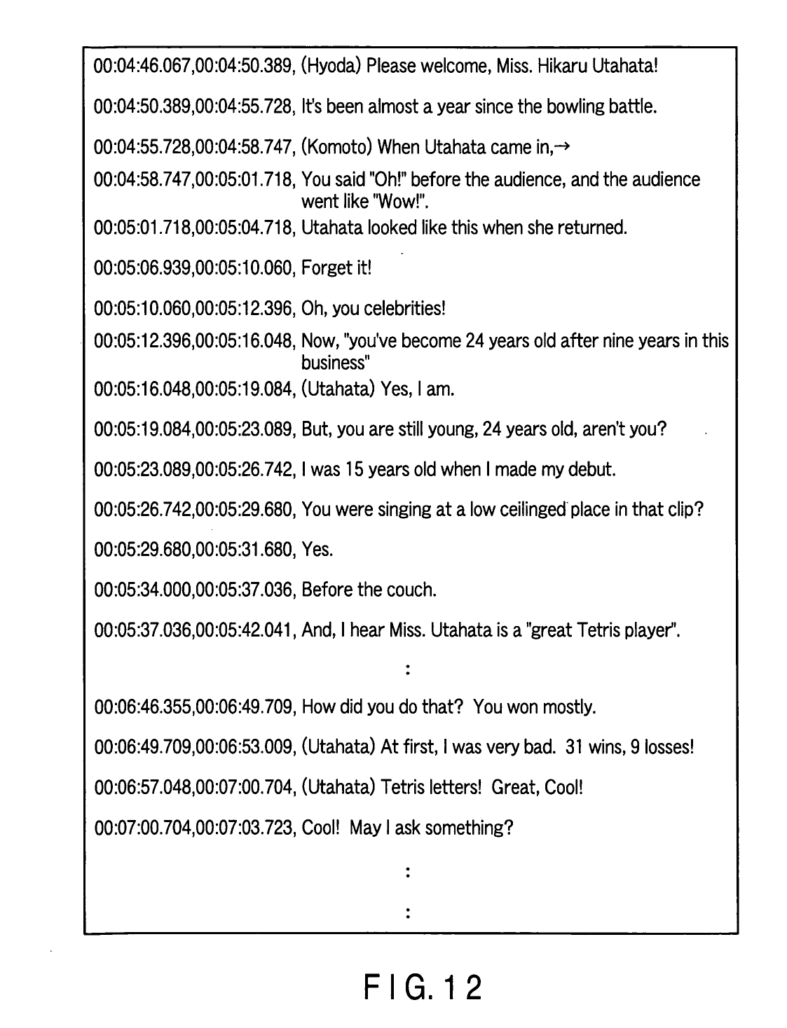

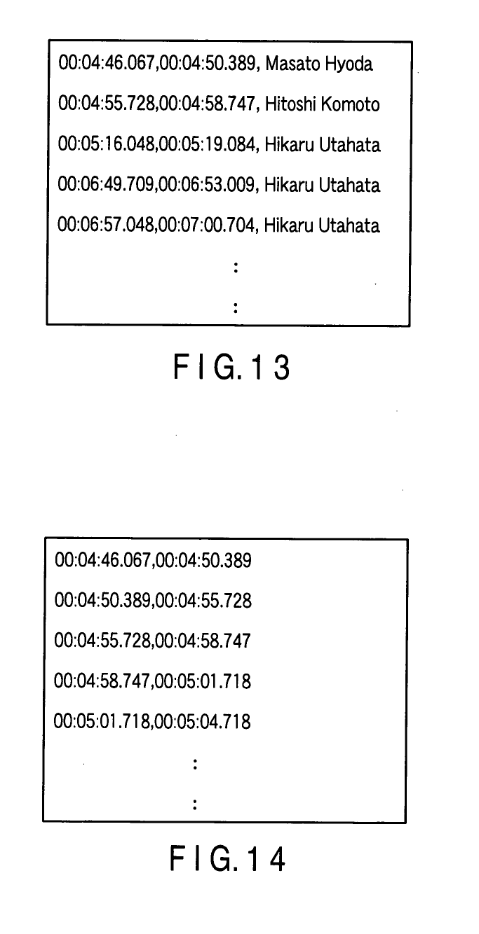

The speaker information acquisition unit 103 acquires speaker information including a speaker name specified by speaker name specifying information used to indicate a speaker name, and an utterance duration of a speaker from utterance content information including utterance content and utterance duration in a video picture. The utterance content information is, for example, a closed caption, and will be described later with reference to FIG. 12. An example of the speaker information will be described later with reference to FIG. 13. The operation of the speaker information acquisition unit 103 will be described later with reference to FIG. 3, and its more practical operation will be described later in practical examples. The utterance period correction unit 104 corrects the utterance duration included in the speaker information acquired by the speaker information acquisition unit 103, and passes the speaker name and the corrected utterance duration of the speaker to the speaker feature amount extraction unit 105. The corrected utterance duration will be referred to as a first utterance period hereinafter. The operation of the utterance period correction unit 104 will be described later with reference to FIG. 4, and its more practical operation will be described later in practical examples.

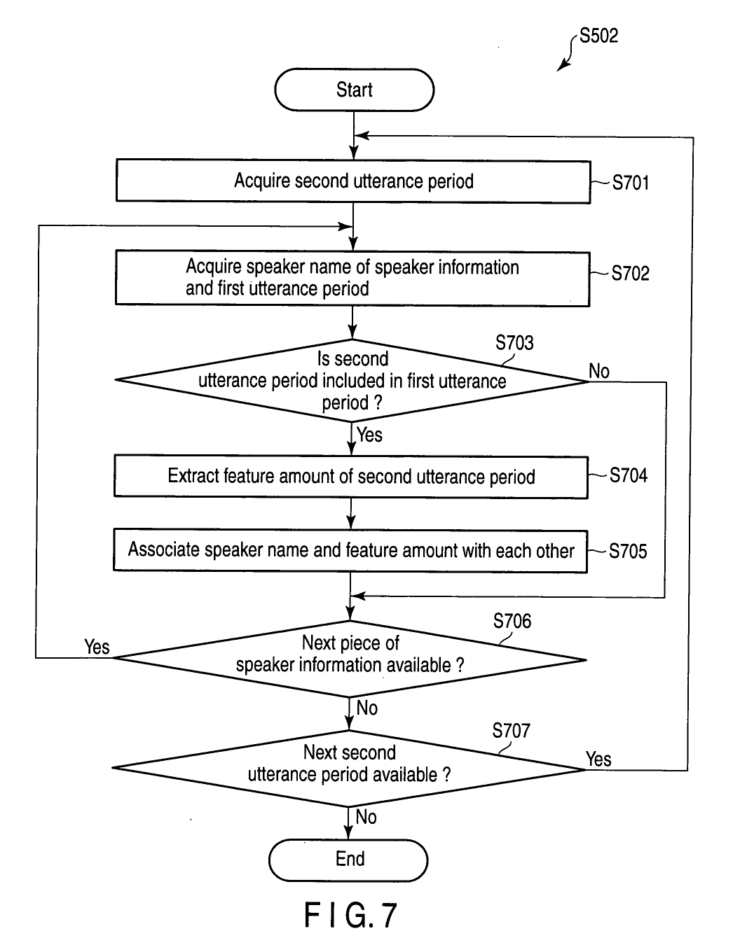

The speaker feature amount extraction unit 105 extracts a feature amount that characterizes the speaker from the speech waveform of the first utterance period corresponding to the utterance duration of the speaker information, and associates the speaker name with the feature amount. The operation of the speaker feature amount extraction unit 105 will be described later with reference to FIG. 7, and its more practical operation will be described later in practical examples.

The speaker model creation unit 106 creates speaker models of speakers based on the feature amounts for respective speakers extracted by the speaker feature amount extraction unit 105. The operation of the speaker model creation unit 106 will be described later with reference to FIG. 5.

The speaker model storage unit 107 stores the speaker models for respective speakers created by the speaker model creation unit 106.

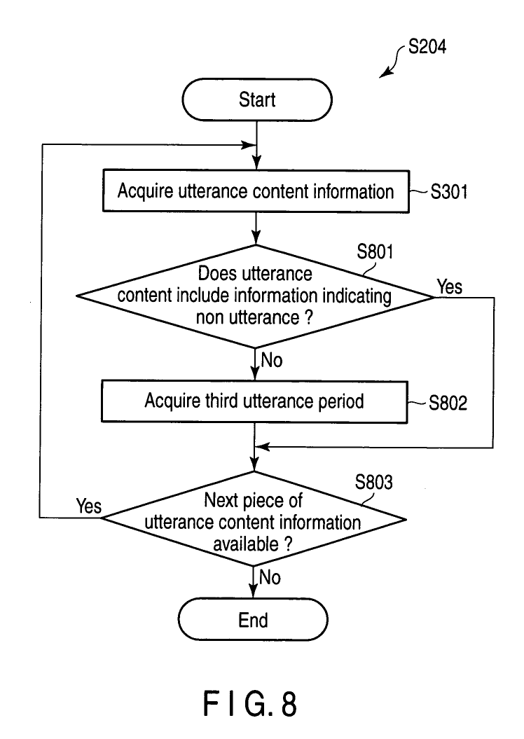

The recognition target duration acquisition unit 108 acquires recognition target duration information including an utterance duration to be recognized from the utterance content information including the utterance content and utterance duration. This utterance duration will be referred to as a third utterance period hereinafter. The operation of the recognition target duration acquisition unit 108 will be described later with reference to FIG. 8, and its more practical operation will be described later in practical examples.

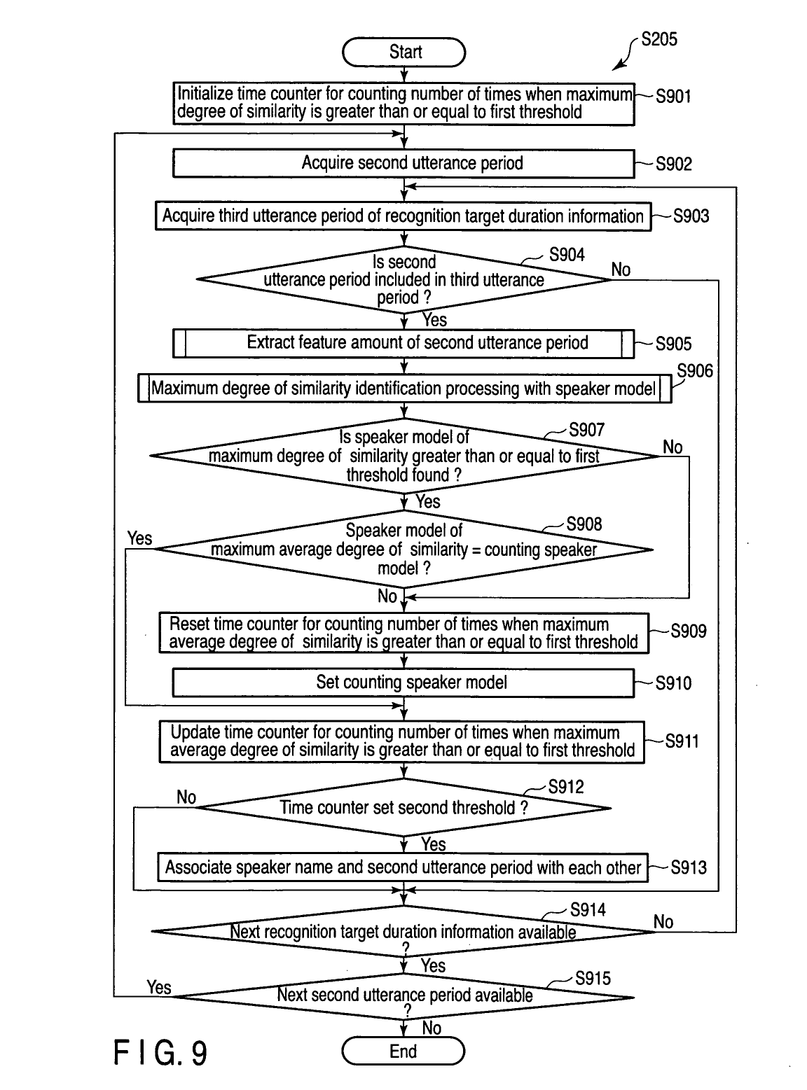

The recognition feature amount extraction unit 109 extracts a feature amount that characterizes the speaker from the speech waveform of the utterance period (third utterance period) corresponding to the utterance duration of the recognition target duration information. The operation of the recognition feature amount extraction unit 109 will be described later with reference to FIG. 9, and its more practical operation will be described later in practical examples.

The similarity calculation unit 110 calculates degrees of similarity between the speaker models for respective speakers stored in the speaker model storage unit 107 and the feature amount for each utterance period (third utterance period) corresponding to the utterance duration of the recognition target duration information. The operation of the similarity calculation unit 110 will be described later with reference to FIG. 9, and its more practical operation will be described later in practical examples.

The recognition unit 111 determines and outputs, as a performer, the speaker name of the speaker model that satisfies a set condition of the degrees of similarity calculated by the similarity calculation unit 110. The operation of the recognition unit 111 will be described later with reference to FIG. 9, and its more practical operation will be described later in practical examples.

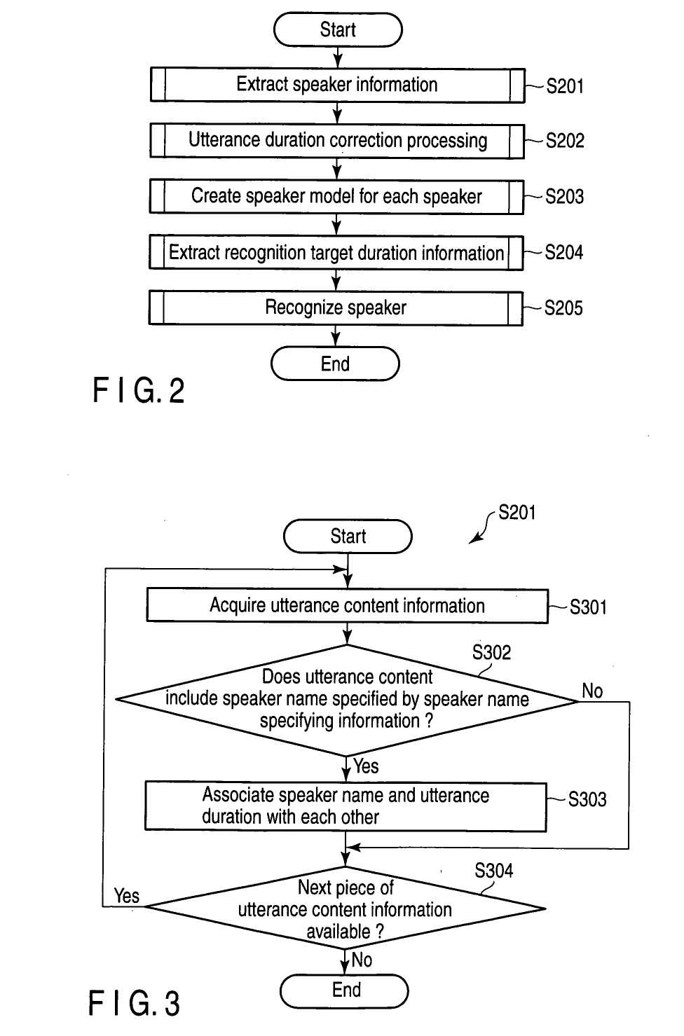

An example of the operation (until a speaker is recognized from a video picture) of the personal name assignment apparatus shown in FIG. 1 will be described below with reference to FIG. 2.

The speaker information acquisition unit 103 extracts speaker information including a speaker name specified by speaker name specifying information used to indicate a speaker name, and an utterance duration (first utterance period) of a speaker from utterance content information including utterance content and an utterance duration in a video picture (step S201). The utterance period correction unit 104 corrects the utterance duration (first utterance period) included in the speaker information (step S202). The speaker model creation unit 106 creates speaker models for respective speakers from utterance periods (second utterance periods) of speech in the video picture, which are specified by the non-silent period extraction unit 101 and utterance reliability determination unit 102 (step S203). Furthermore, the recognition target duration acquisition unit 108 extracts recognition target duration information including an utterance duration (third utterance period) to be recognized from the utterance content information including the utterance content and utterance duration in the video picture (step S204). Finally, the recognition feature amount extraction unit 109 extracts a feature amount from the speech waveform of the utterance duration (third utterance period) corresponding to the utterance duration included in the recognition target duration information, the similarity calculation unit 110 calculates degrees of similarity between the feature amount for each third utterance period and those of the speaker models for respective speakers, and the recognition unit 111 determines the speaker name of the utterance period (step S205). The detailed operations of the respective steps will be described below with reference to the drawings.

An example of the processing for extracting speaker information (step S201) in FIG. 2 will be described below with reference to FIG. 3. Step S201 is executed by the speaker information acquisition unit 103.

The speaker information acquisition unit 103 acquires utterance content information which is attached to a video picture and includes utterance content and an utterance duration (step S301). The unit 103 checks if the utterance content of the utterance content information includes a speaker name specified by speaker name specifying information used to indicate a speaker name (step S302). If it is determined in step S302 that no speaker name specified by the speaker name specifying information is included, the unit 103 checks if the next utterance content information is available (step S304). If it is determined in step S302 that a speaker name specified by the speaker name specifying information is included, the unit 103 associates the speaker name with the utterance duration of the utterance content (step S303), and checks if the next utterance content information is available (step S304). If it is determined in step S304 that the next utterance content information is available, the process returns to step S301 to acquire the next utterance content information; otherwise, the unit 103 ends the operation.

An example of the processing for correcting an utterance duration (step S202) in FIG. 2 will be described below with reference to FIG. 4. Step S202 is executed by the utterance period correction unit 104.

The utterance period correction unit 104 acquires utterance content information from the video picture (step S301). The unit 104 morphologically analyzes a dialogue content obtained by excluding the speaker name from the utterance content included in the utterance content information, and assigns its reading (step S401). The unit 104 sets the reading of the dialogue content in a speech recognition grammar (step S402). The unit 104 acquires speech corresponding to the utterance duration included in the utterance content information from the video picture (step S403). The unit 104 applies speech recognition to the speech acquired in step S403 (step S404), and replaces the utterance duration included in the utterance content information by duration information of an utterance duration (first utterance period) based on the speech recognition result (step S405). If the next utterance content information is available, the process returns to step S301; otherwise, the unit 104 ends the operation (step S406).

An example of the processing for creating speaker models (step S203) in FIG. 2 will be described below with reference to FIG. 5.

The non-silent period extraction unit 101 and utterance reliability determination unit 102 extract utterance periods (second utterance periods) of speech in the video picture (step S501). The speaker feature amount extraction unit 105 extracts a feature amount of a speaker from the speech waveform of the first utterance period obtained by correcting the utterance period corresponding to the utterance duration included in the speaker information, and associates a speaker name included in speaker information with the feature amount (step S502). The speaker model creation unit 106 creates the feature amount associated with the speaker name as a speaker model for each speaker (step S503). Finally, the speaker model storage unit 107 stores the speaker model for each speaker (step S504). In the processing for creating the feature amount associated with the speaker name as a speaker model for each speaker (step S503), the feature amount of a speaker is created using a VQ model used in “Y. Linde, A. Buzo, and R. M. Gray “An algorithm for vector quantizer design” IEEE Trans. Commun. vol. COM-28, no. 1, pp. 84-95, January 1980”, a GMM model used in “Reynolds, D. A., Rose, R. C. “Robust text-independent speaker identification using Gaussian Mixture Speaker Models” IEEE Trans. Speech and Audio Processing. Vol. 3 no. 1, pp. 72-83, January 1995”, or the like, and a speaker model for each speaker is stored (step S504). At this time, a speaker model may be created only for a speaker who has a total duration, which is greater than or equal to a threshold, of all utterance periods corresponding to utterance durations of pieces of speaker information.

Detailed operations in steps S501 and S502 will be described below.

An example of the processing for extracting utterance periods (second utterance periods) of speech in a video picture (step S501) in FIG. 5 will be described below with reference to FIG. 6.

The non-silent period extraction unit 101 acquires speech periods in the video picture (step S601). For example, the unit 101 acquires the speech of set frame intervals from speech in the video picture. The non-silent period extraction unit 101 checks if each speech period acquired in step S601 is a non-silent period (step S602). The non-silent period may be determined by using any of existing methods as long as they determine a non-silent period (for example, a frame in which the average of power spectra obtained by FFT is greater than or equal to a threshold may be determined as a non-silent frame).

If the speech period is determined as a non-silent period in step S602, the utterance reliability determination unit 102 checks if this non-silent period is a period including audience noise such as laughing, applause, cheers, and the like or music (step S603). For example, a non-silent frame with high reliability is extracted. If the non-silent frame does not include any audience noise such as laughing, applause, cheers, and the like or any music, the unit 102 determines that the non-silent frame has high reliability, and extracts that frame. As a method of determining audience noise, a correlation between a feature amount of the power spectra of difference speech obtained by removing a speech of an announcer or commentator from the difference between right and left channels, and an audience noise model feature amount is calculated, and a period in which the correlation is greater than or equal to a threshold is determined as an audience noise period. Determination of audience noise is not limited to the aforementioned method, and any other existing methods, such as a method described in JP-A 09-206291 (KOKAI), and the like may be used. As a method of determining music, for example, when a spectral peak is temporally stable in the frequency direction, a music period is determined. Determination of music is not limited to the aforementioned method, and any other existing methods, such as a method described in JP-A 10-307580 (KOKAI), and the like may be used.

If it is determined in step S603 that the non-silent period is not a period including audience noise or music, the utterance reliability determination unit 102 extracts that non-silent period as a second utterance period (step S604), and checks if the next speech period is available (step S605). For example, it is checked if a speech frame which is obtained by extracting a non-silent frame as an utterance period, and shifting it by a set shift width is available. If it is determined that the next speech period is available, the process returns to step S601, otherwise, the operation ends.

An example of the processing for extracting the feature amount of a speaker from the speech waveform of the first utterance period obtained by correcting the utterance period corresponding to the utterance duration of the speaker information, and associating the speaker name with the feature amount (step S502) in FIG. 5 will be described below with reference to FIG. 7. Step S502 is executed by the speaker feature amount extraction unit 105.

The speaker feature amount extraction unit 105 acquires a second utterance period from the utterance reliability determination unit 102 (step S701). The unit 105 then acquires the speaker name of speaker information and a first utterance period from the utterance period correction unit 104 (step S702). The unit 105 checks if the second utterance period acquired in step S701 in FIG. 7 is included in the first utterance period acquired in step S702 (step S703). If it is determined that the second utterance period is included in the first utterance period, the unit 105 extracts a feature amount of the second utterance period (step S704), associates the feature amount acquired in step S704 with the speaker name (step S705), and checks if the next piece of speaker information is available (step S706). If the next piece of speaker information is available, the process returns to step S702. If it is determined that the next piece of speaker information is not available, the unit 105 checks if the next second utterance period is available (step S707). If it is determined that the next second utterance period is available, the process returns to step S701; otherwise, the unit 105 ends the operation.

An example of the processing for extracting recognition target duration information (step S204) in FIG. 2 will be described below with reference to FIG. 8. Step S204 is executed by the recognition target duration acquisition unit 108.

The recognition target duration acquisition unit 108 acquires utterance content information which is attached to a video picture and includes utterance content and an utterance duration (step S301). The unit 108 checks if the utterance content information includes information indicating non-utterance (step S801). If it is determined that the utterance content information does not include any information indicating non-utterance, the unit 108 acquires a third utterance period (step S802). The unit 108 checks if the next utterance content information is available (step S803). If it is determined that the next piece of utterance content information is available, the process returns to step S301 to acquire the next piece of utterance content information. If it is determined that the next piece of utterance content information is not available, the unit 108 ends the operation.

An example of the processing for recognizing a speaker (step S205) in FIG. 2 will be described below with reference to FIG. 9.

The similarity calculation unit 110 initializes its internal time counter (not shown) for counting the number of times when a maximum degree of similarity is greater than or equal to a first threshold (step S901). The recognition feature amount extraction unit 109 acquires a second utterance period (step S902). The utterance acquires a third utterance period of recognition target duration information (step S903). The recognition feature amount extraction unit 109 checks if the second utterance period acquired in step S902 is included in the third utterance period (step S904). If it is determined that the second utterance period is included in the third utterance period, the recognition feature amount extraction unit 109 extracts a feature amount of the second utterance period (step S905). If it is determined that the second utterance period is not included in the third utterance period, the process jumps to step S914.

The similarity calculation unit 110 calculates degrees of similarity between the feature amount extracted in step S905 and those of stored speaker models (step S906). The similarity calculation unit 110 checks if a speaker model of a maximum degree of similarity greater than or equal to a first threshold is available (step S907). If the similarity calculation unit 110 determines in step S907 that the speaker model of the maximum degree of similarity is available, it checks if that speaker model is the same as a counting speaker model (step S908). If the similarity calculation unit 110 determines in step S907 that no speaker model of a maximum a degree of similarity is available or determines in step S908 that the speaker model of the maximum degree of similarity is not the same as the counting speaker model, it resets the time counter (step S909), and sets the counting speaker mode as a new speaker model (step S910). If the similarity calculation unit 110 determines in step S908 that the speaker model of the maximum degree of similarity is the same as the counting speaker model, or after step S910, it updates the time counter (step S911). The similarity calculation unit 110 checks if the time counter is greater than or equal to a set second threshold (step S912).

If it is determined that the time counter is greater than or equal to the second threshold, the recognition unit 111 associates the performer name of the counting speaker model with the second utterance period (step S913). If it is determined that the time counter is not greater than or equal to the second threshold, the process skips step S913 and advances to step S914. The recognition feature amount extraction unit 109 checks if the next piece of recognition target duration information is available (step S914). If it is determined that the next recognition target duration information is available, the process returns to step S903. If the next recognition target duration information is not available, the recognition feature amount extraction unit 109 checks if the next second utterance period is available (step S915). If the next second utterance period is available, the process returns to step S902; otherwise, the operation ends.

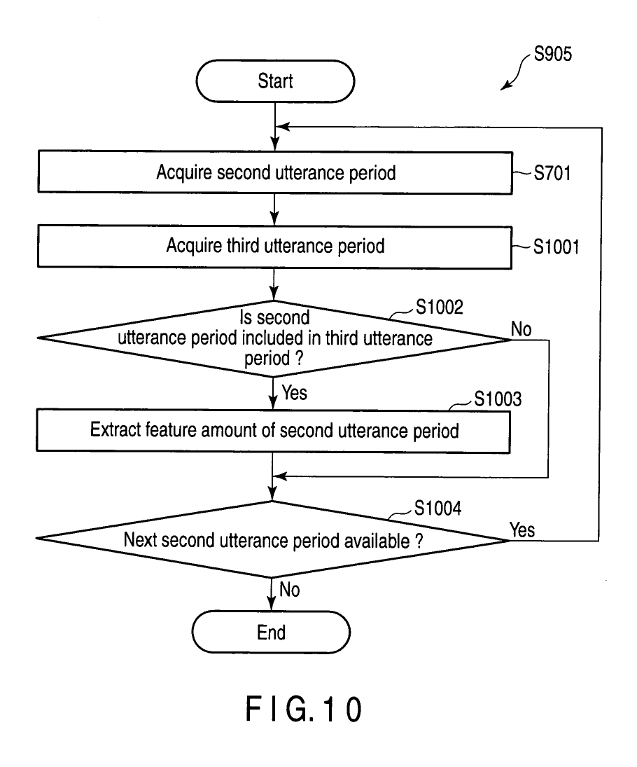

The operation of the processing for acquiring the feature amount of the second utterance period (step S905) in FIG. 9 will be described below with reference to FIG. 10. Step S905 is executed by the recognition feature amount extraction unit 109.

The recognition feature amount extraction unit 109 acquires a second utterance period from the utterance reliability determination unit 102 (step S701). The unit 109 then acquires a third utterance period from the recognition target duration acquisition unit 108 (step S1001). The unit 109 checks if the second utterance period acquired in step S701 in FIG. 9 is included in the third utterance period acquired in step S1001 (step S1002). If it is determined that the second utterance period is included in the third utterance period, the unit 109 extracts a feature amount of the second utterance period (step S1003). The unit 109 checks if the next second utterance period is available (step S1004). If it is determined that the next second utterance period is available, the process returns to step S701 in FIG. 10; otherwise, the unit 109 ends the operation.

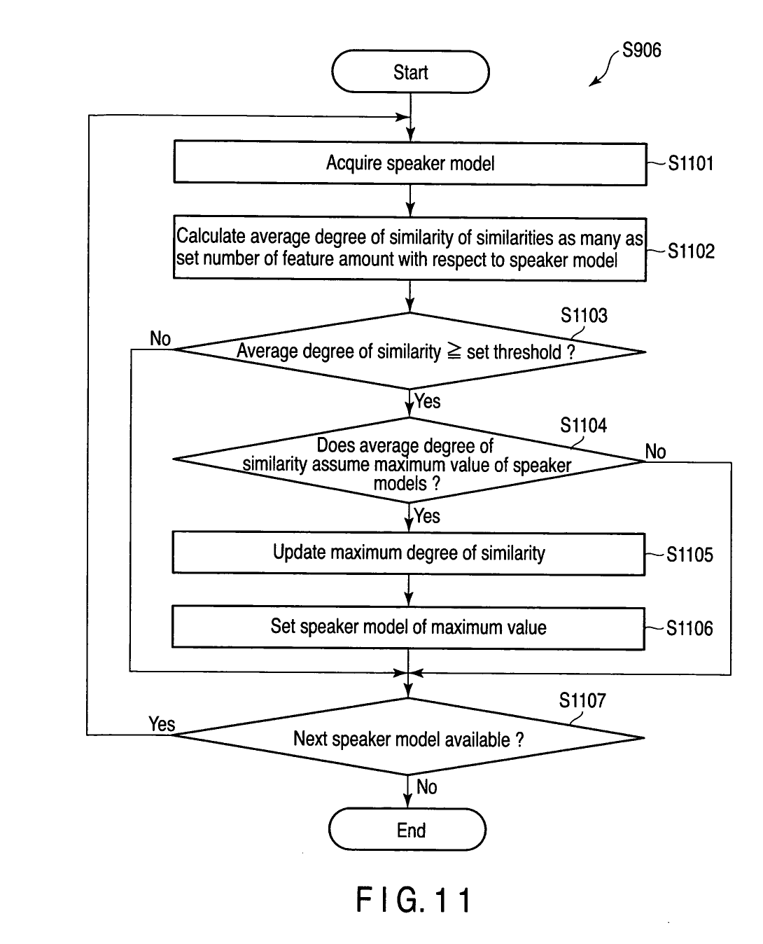

An example of the processing for calculating the degrees of similarity between the extracted feature amount and those of stored speaker models, and identifying a speaker model of a maximum degree of similarity greater than or equal to the threshold (step S906) in FIG. 9 will be described below with reference to FIG. 11. Step S906 is executed by the similarity calculation unit 110.

The similarity calculation unit 110 acquires a speaker model from the speaker model storage unit 107 (step S1101). The unit 110 calculates an average degree of similarity of degrees as many as the pre-set number of periods each between the feature amount of the second utterance period extracted in step S905 and the feature amount of each speaker model (step S1102). Note that the “period” as in the number of periods indicates the second utterance period of the extracted feature amount.

The similarity calculation unit 110 calculates an average degree of similarity of degrees as many as the pre-set number of periods each between the extracted feature amount and that of the speaker model (S1102). The similarity calculation unit 110 holds feature amounts as many as the pre-set number of periods, and calculates an average degree of similarity of degrees between them and a new feature amount input. For example, when a VQ model is used in creation of a speaker model, VQ distortions as many as the number of previously set frames are considered. The VQ distortion indicates the degree of difference between the extracted feature amount and that of a speaker model (the distance between the extracted feature amount and that of the speaker model). Therefore, the reciprocal number of the VQ distortion corresponds to a degree of similarity. An average degree of similarity is calculated by calculating the reciprocal number of a value obtained by dividing the sum total of VQ distortions (degrees of difference) between the extracted feature amount and feature amounts for each speaker model as many as the pre-set number of periods by the number of periods.

The similarity calculation unit 110 checks if the average degree of similarity is greater than or equal to a set threshold (step S1103). If it is determined that the average degree of similarity is greater than or equal to the threshold, the unit 110 checks if the average degree of similarity assumes a maximum value of those of speaker models (step S1104). If it is determined that the average degree of similarity assumes a maximum value, the unit 110 updates the average degree of similarity of the maximum value (step S1105), and sets the speaker model of the maximum value (step S1106). The unit 110 checks if the next speaker model is available (step S1107). If the next speaker model is available, the process returns to step S1101; otherwise, the unit 110 ends the operation.

(Practical Operation Example)

Practical operation examples of the personal name assignment apparatus when the aforementioned utterance content information is a closed caption will be described below. FIG. 12 shows an example of closed captions.

MPEG2-TS as a digital broadcasting protocol allows multiple transmission of various data (closed captions, EPG, BML, etc.) required for the broadcasting purpose in addition to audio and video data. The closed captions are transmitted as text data of utterance contents of performers together with utterance durations and the like, so as to help television viewing of hearing-impaired people.

In each closed caption, when a speaking performer cannot be discriminated from a video picture alone (for example, when a plurality of performers appear in a video picture, when no speaker appears in a video picture, and so forth), a performer name in symbols such as parentheses or the like is written before utterance content in some cases. However, since not all the utterance contents of closed captions include performer names, speaking performers in all scenes are not always recognized based only on the closed captions.

The processing for extracting speaker information (step S201) in FIG. 2 will be explained below using the flowchart shown in FIG. 3.

The speaker information acquisition unit 103 acquires a closed caption including utterance content and an utterance duration (step S301). For example, closed captions included in terrestrial digital broadcasting are transmitted based on “Data Coding and Transmission Specification for Digital Broadcasting ARIB STANDARD (ARIB STD-B24)” specified by Association of Radio Industries and Businesses. Transmission of a closed caption uses a PES (Packetized Elementary Stream) format, which includes a display instruction time and caption text data. The caption text data includes character information to be displayed, and control symbols such as screen control, character position movement, and the like. In step S201, the closed caption display start time is calculated using the display instruction time. Also, the end time is determined to select the earlier one of a time at which a screen clear instruction based on screen control is generated or the display instruction time of a closed caption including the next display content. As a result, a triad of “start time, end time, utterance content” can be acquired.

FIG. 12 illustrates the transmitted closed captions using the aforementioned triads. When “00:04:46.067, 00:04:50.389, (Hyoda) Please welcome, Miss. Hikaru Utahata!” is acquired according to FIG. 12, the speaker information acquisition unit 103 checks if the utterance content of the closed caption includes a speaker name specified by speaker name specifying information used to indicate a speaker name (step S302). In this case, since “Hyoda” in parentheses used to indicate a speaker name is included, the unit 103 associates the speaker name “Hyoda” and utterance duration “00:04:46.067, 00:04:50.389” with each other (step S303). The unit 103 checks if the next closed caption is available (step S304).

Since the next closed caption is available in the example of FIG. 12, the process returns to step S301 to acquire a closed caption “00:04:50.389, 00:04:55.728, It's been almost a year since the bowling battle.” (step S301). The speaker information acquisition unit 103 checks if the utterance content includes a speaker name in parentheses used to indicate a speaker name (step S302). In this case, since no speaker name in parentheses is included, the unit 103 checks if the next closed caption is available (step S304). The unit 103 processes these steps until all closed captions are processed. When a plurality of speaker names in parentheses appear in the utterance content, the utterance duration may be divided by the number of speaker names to associate the speaker names with the respective durations or association between the speaker names and utterance durations may be skipped.

FIG. 13 shows an example of speaker information. Note that speaker names are corrected to full names using performer name information in an EPG (Electronic Program Guide). In the processing for correcting an utterance duration to be executed by the utterance period correction unit 104 (step S202), the utterance duration of a closed caption is corrected. In the closed caption, if the utterance content is short, an utterance duration longer than an actual utterance duration is often set to adjust its display duration to those of other utterance contents. For this reason, the processing for correcting the utterance duration to an actual utterance duration is executed.

Speech is recognized by speech recognition, and the recognition result is compared with the utterance content of the closed caption. If the utterance content and the speech recognition result match, the utterance duration of the utterance content information is corrected to a duration in which that speech is recognized. In a speech recognition method, for example, the degrees of similarity or distances between stored speech models of words to be recognized and a feature parameter sequence of speech are calculated, and words associated with the speech models with a maximum degree of similarity (or a minimum distance) are output as a recognition result. As a collation method, a method of also expressing speech models by feature parameter sequences, and calculating the distances between the feature parameter sequences of speech models and that of input speech by DP (dynamic programming), a method of expressing speech models using an HMM (hidden Markov model), and calculating the probabilities of respective speech models upon input of the feature parameter sequence of input speech, and the like are available. The speech recognition method is not limited to the aforementioned method, and any other existing speech recognition method may be used as long as it has a function of recognizing speech from a video picture and detecting a speech appearance period.

The processing for extracting a feature for each speaker name (S302) in FIG. 5 will be described below using FIG. 7. The speaker feature amount extraction unit 105 acquires the speech frame as the second utterance period extracted in step S501 (step S701). The unit 105 then acquires the speaker name of speaker information and an utterance duration (first utterance duration) (step S702). In the case of the speaker information shown in FIG. 13, the unit 105 acquires a speaker name “Masato Hyoda” and an utterance duration “00:04:46.067, 00:04:50.389” (step S702). The unit 105 checks if the second utterance period acquired in step S701 is included in the first utterance period acquired in step S702 (step S703). If the speech frame (second utterance period) is included in the utterance duration (first utterance period), the unit 105 extracts a feature amount of the speech frame (step S704). The feature amount can be an acoustic feature amount for the purpose of classification for respective speakers such as an LPC cepstrum, MFCC, and the like. The unit 105 then associates the speaker name “Masato Hyoda” acquired in step S702 with the feature amount (step S705). The unit 105 checks if the next piece of speaker information is available (step S706). If the next piece of speaker information is available, the process returns to step S702. Since the next piece of speaker information is available in FIG. 13, the unit 105 acquires a speaker name “Hitoshi Komoto” as the next piece of speaker information and an utterance duration “00:04:55.728, 00:04:58.747” (step S702). Likewise, if the speech frame (second utterance period) is included in the utterance duration (first utterance period), the unit 105 extracts a feature of the speech frame, and repeats steps S702 to S706 until the last piece of speaker information. If the next piece of speaker information is not available in step S706, the unit 105 checks if the next speech frame is available (step S707). If the next speech frame is available, the process returns to step S701 to acquire the next speech frame and to repeat steps S702 to S706 from the first speaker information. The unit 105 repeats these steps until all speech frames are processed.

The processing for extracting recognition target duration information (step S204) in FIG. 2 will be described below using FIG. 8. Step S204 is executed by the recognition target duration acquisition unit 108.

In a closed caption, in the case of no utterance such as music, CM, or the like, an utterance duration is omitted, or information indicating non-utterance is described in utterance content. The recognition target duration acquisition unit 108 acquires utterance content and an utterance duration of a closed caption (step S301). In FIG. 12, the unit 108 acquires “00:04:46.067, 00:04:50.389, (Hyoda) Please welcome, Miss. Hikaru Utahata!”. The unit 108 checks if the utterance content information includes information indicating non-utterance (step S801). If the utterance content information does not include any information indicating non-utterance, the unit 108 acquires an utterance duration (third utterance period) (step S802). Since the utterance content information does not include any information indicating non-utterance, the unit 108 acquires an utterance duration “00:04:46.067, 00:04:50.389”. The unit 108 then checks if the next closed caption is available (step S803).

If the next closed caption is available, the process returns to step S301 to acquire the next closed caption “00:04:50.389, 00:04:55.728, It's been almost a year since the bowling battle.” The recognition target duration acquisition unit 108 then checks if the utterance content information includes information indicating non-utterance (step S801). If the utterance content information does not include any information indicating non-utterance, the unit 108 acquires an utterance duration (third utterance period) (step S802). Since the utterance content information does not include any information indicating non-utterance, the unit 108 acquires an utterance duration “00:04:50.389, 00:04:55.728”. The unit 108 then checks if the next closed caption is available (step S803). The unit 108 repeats steps S301 to S803 until all the closed captions are processed. FIG. 14 shows an example of the extraction result of recognition target duration information. The processing for extracting recognition target duration information may select all durations of speech in a video picture as recognition target durations.

The processing for recognizing a speaker (step S205) in FIG. 2 will be described below using FIGS. 9 and 11.

The similarity calculation unit 110 sets the time counter for counting the number of times when a maximum degree of similarity is greater than or equal to the threshold to “0” (step S901). The recognition feature amount extraction unit 109 acquires a speech frame (second utterance period) (step S902). The recognition feature amount extraction unit 109 then acquires an utterance duration of recognition target duration information (third utterance period) (step S903). In the example of FIG. 14, the unit 109 acquires a recognition target duration “00:04:46.067, 00:04:50.389”. The recognition feature amount extraction unit 109 checks if the acquired speech frame is included in the utterance duration (step S904). If the speech frame is included in the utterance duration, the recognition feature amount extraction unit 109 extracts a feature amount of the speech frame (step S905). At this time, the unit 109 extracts a feature amount by the calculation method used in the processing for extracting a feature for each speaker name (step S502).

The similarity calculation unit 110 calculates degrees of similarity of the extracted feature amount with stored speaker models, and identifies a speaker model of a maximum degree of similarity greater than or equal to the threshold (step S906). The similarity calculation unit 110 checks if a speaker model of a maximum degree of similarity greater than or equal to the threshold is found (step S907). If the speaker model of a maximum degree of similarity is found, the similarity calculation unit 110 checks if that speaker model matches a counting speaker model (step S908). If the found speaker model does not match the counting speaker model, the similarity calculation unit 110 resets the time counter to “0” (step S909), and sets the counting speaker model as a new speaker model (step S910). If the found speaker model matches the counting speaker model, the similarity calculation unit 110 increments the time counter by “1” (step S911). The similarity calculation unit 110 checks if the time counter is greater than or equal to the set threshold (step S912).

If the time counter is greater than or equal to the threshold, the recognition unit 111 associates the performer name of the counting speaker model with the speech period (step S913). The recognition feature amount extraction unit 109 checks if the next recognition target duration information is available (step S914). If the next recognition target duration information is available, the process returns to step S903. In FIG. 14, a recognition time duration “00:04:50.389, 00:04:55.728” is acquired. If the next recognition target time duration information is not available, the recognition feature amount extraction unit 109 checks if the next speech frame is available (step S915). If the next speech frame is available, the process returns to step S902; otherwise, the operation ends.

According to the aforementioned embodiment, since a speaker model is created from speech in a video picture, the need for updating a speech database is obviated, and a personal name can be assigned to a scene where a desired performer appears based solely on a received video picture. Using only speech and text information, the processing time can be shortened.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A personal name assignment apparatus comprising:
a first acquisition unit configured to acquire speaker information including a first utterance duration of a speaker and a speaker name specified by speaker name specifying information used to indicate a speaker name, from utterance content information which includes utterance content and a second utterance duration in a video picture and is attached to the video picture, and to acquire the first utterance duration as a first utterance period;
a second acquisition unit configured to acquire, from a non-silent period in the video picture, a second utterance period including an utterance;
a first extraction unit configured to extract, if the second utterance period is included in the first utterance period, a first feature amount that characterizes a speaker from a speech waveform of the second utterance period, and to associate the first feature amount with a speaker name corresponding to the first utterance period;
a creation unit configured to create a plurality of speaker models of speakers from feature amounts for respective speakers;
a storage unit configured to store speaker names and the speaker models in relationship to each other;
a third acquisition unit configured to acquire, from the utterance content information, a third utterance duration as an utterance duration to be recognized;
a second extraction unit configured to extract, if the second utterance period is included in the third utterance period, a second feature amount that characterizes a speaker from the speech waveform;
a calculation unit configured to calculate a plurality of degrees of similarity between feature amounts of speaker models for respective speakers and the second feature amount; and
a recognition unit configured to recognize a speaker name of a speaker model which satisfies a set condition of the degrees of similarity as a performer.

2. The apparatus according to claim 1, further comprising a setting unit configured to set, as the first utterance period, an utterance duration acquired by correcting the first utterance duration, and
wherein the second acquisition unit includes:
a third extraction unit configured to extract non-silent periods at set shift intervals from periods each having a set period width from speech in the video picture, the non-silent period being included in the non-silent periods; and
a fourth acquisition unit configured to acquire, as the second utterance period, one of an utterance periods acquired by excluding non-utterance periods from the non-silent periods.

3. The apparatus according to claim 2, wherein the fourth acquisition unit determines a first period including audience noise as a period of no reliability from the non-silent periods, and fails to acquire the first period as the second utterance period.

4. The apparatus according to claim 2, wherein the fourth acquisition unit determines a second period including music as a period of no reliability from the non-silent periods, and fails to acquire the second period as the second utterance period.

5. The apparatus according to claim 2, wherein the setting unit compares the utterance content with a speech recognition result of speech in the video picture, and corrects the first utterance duration to a duration in which the speech is recognized if the utterance content matches the speech recognition result.

6. The apparatus according to claim 1, wherein the first acquisition unit acquires, as the utterance content information, the speaker information from a closed caption.

7. The apparatus according to claim 6, wherein if a plurality of speaker names appear in one piece of utterance content, the first acquisition unit divides the second utterance duration by number of speaker names, and associates the speaker names with utterance durations for respective speaker names.

8. The apparatus according to claim 6, wherein if a plurality of speaker names appear in one piece of utterance content, the first acquisition unit fails to acquire the first utterance period.

9. The apparatus according to claim 1, wherein the creation unit creates a speaker model only for a speaker who has a total time of the first utterance periods not less than a threshold, the speaker model being included in the speaker models.

10. A personal name assignment method comprising:
acquiring speaker information including a first utterance duration of a speaker and a speaker name specified by speaker name specifying information used to indicate a speaker name, from utterance content information which includes utterance content and a second utterance duration in a video picture and is attached to the video picture, and to acquire the first utterance duration as a first utterance period;
acquiring, from a non-silent period in the video picture, a second utterance period including an utterance;
extracting, if the second utterance period is included in the first utterance period, a first feature amount that characterizes a speaker from a speech waveform of the second utterance period, and to associate the first feature amount with a speaker name corresponding to the first utterance period;
creating a plurality of speaker models of speakers from feature amounts for respective speakers;
storing in a storage unit speaker names and the speaker models in relationship to each other;
acquiring, from the utterance content information, a third utterance duration as an utterance duration to be recognized;
extracting, if the second utterance period is included in the third utterance period, a second feature amount that characterizes a speaker from the speech waveform;
calculating a plurality of degrees of similarity between feature amounts of speaker models for respective speakers and the second feature amount; and
recognizing a speaker name of a speaker model which satisfies a set condition of the degrees of similarity as a performer.
